(19) United States
(12) Patent Application Publication
(10) Pub. No.: US 2015/0042270 A1
(43) Pub. Date: Feb. 12, 2015

(54) WIRELESS CHARGING DEVICE

(71) Applicants: Foxconn Technology Co., Ltd., New Taipei (TW); CHAMP TECH OPTICAL (FOSHAN) CORPORATION, Foshan (CN)

(72) Inventors: HAI-LIN CHEN, Foshan (CN); DI-QIONG ZHAO, Foshan (CN); CHING-HSING HUANG, New Taipei (TW)

(73) Assignees: FOXCONN TECHNOLOGY CO., LTD., New Taipei (TW); CHAMP TECH OPTICAL (FOSHAN) CORPORATION, Foshan (CN)

(21) Appl. No.: 14/050,374

(22) Filed: Oct. 10, 2013

(30) Foreign Application Priority Data
Aug. 9, 2013 (CN) 2013103447686

(51) Int. Cl. H02J 7/02

(52) U.S. Cl. CPC H02J 7/025; H02J 7/0052
USPC 320/108

(57) ABSTRACT

The present disclose relates to a charging device for charging portable electronic devices. The charging device includes a transmitting unit, a receiving unit and an output port. The transmitting unit includes a first coil for generating electromagnetic signals for charging the portable electronic device. The receiving unit includes a charging panel and at least one second coil arranged on the charging panel. The at least one second coil receives the electromagnetic signals generated by the transmitting unit to generate induction currents. The output port is electrically connected to the receiving unit for outputting the induction currents. The portable electronic device is selectively electrically connected to the charging panel or the output port for charging.

### BACKGROUND

1. Technical Field

The disclosure relates to a charging system, and particularly to a wireless charging device.

2. Discussion of Related Art

With the continued improvements in the field of Information Technology (IT) and the increasing prevalence of a wide variety of portable electronic products, a variety of techniques have been developed that supply power for portable electronic products. Technology for supplying power typically used a power line in the past. However, wireless power transmission technology, which is capable of wirelessly supplying power, has recently been developed.

Wireless power transmission technology includes technology for delivering electrical energy in the form of electromagnetic waves, electromagnetic induction, or electromagnetic resonance, for example. Wireless power transmission technology makes it possible to supply power wirelessly anytime and anywhere, without the use of power lines, such as, electric wires. However, conventional wireless charging device can only charge the portable electronic products with function of wireless charging. In other words, the conventional wireless charging device cannot charge the portable electronic products without function of wireless charging. Thus, the use of the conventional wireless charging device is limited.

Therefore, what is needed is a wireless charging device which can overcome the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present light emitting diode device for microminiaturization. Moreover, in the drawing, like reference numerals designate corresponding parts throughout the whole view.

FIG. 1 is a schematic, isometric view of a wireless charging device according to an exemplary embodiment.

FIG. 2 is a disassembled view of the wireless charging device of FIG. 1.

FIG. 3 is a partially assembled view of the wireless charging device of FIG. 1.

FIG. 4 is similar to FIG. 1, but showing a portable electronic product being charged via a charging panel of the wireless charging device.

FIG. 5 is similar to FIG. 1, but showing another portable electronic product being charged via a port of the wireless charging device.

### DETAILED DESCRIPTION OF EMBODIMENTS

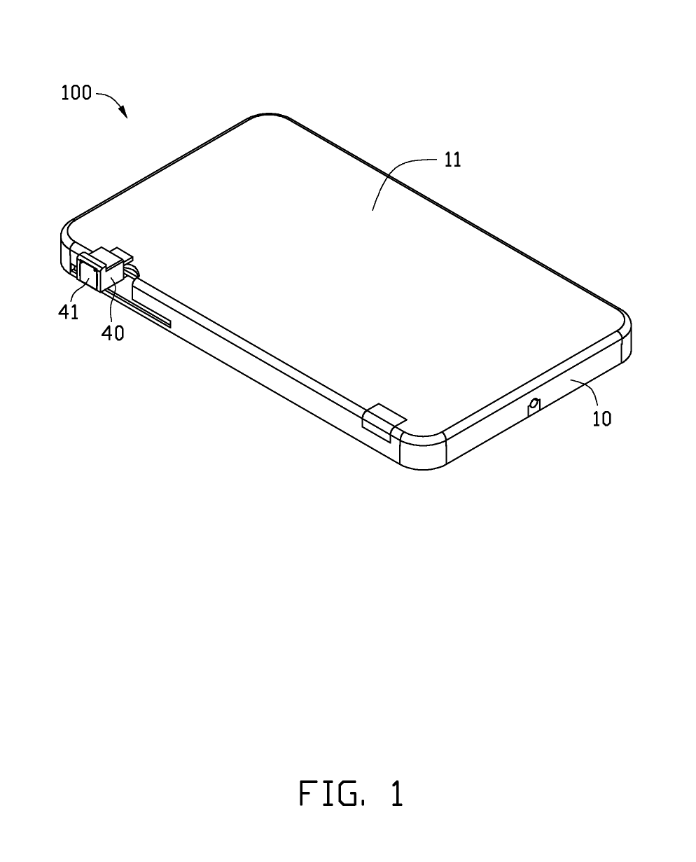

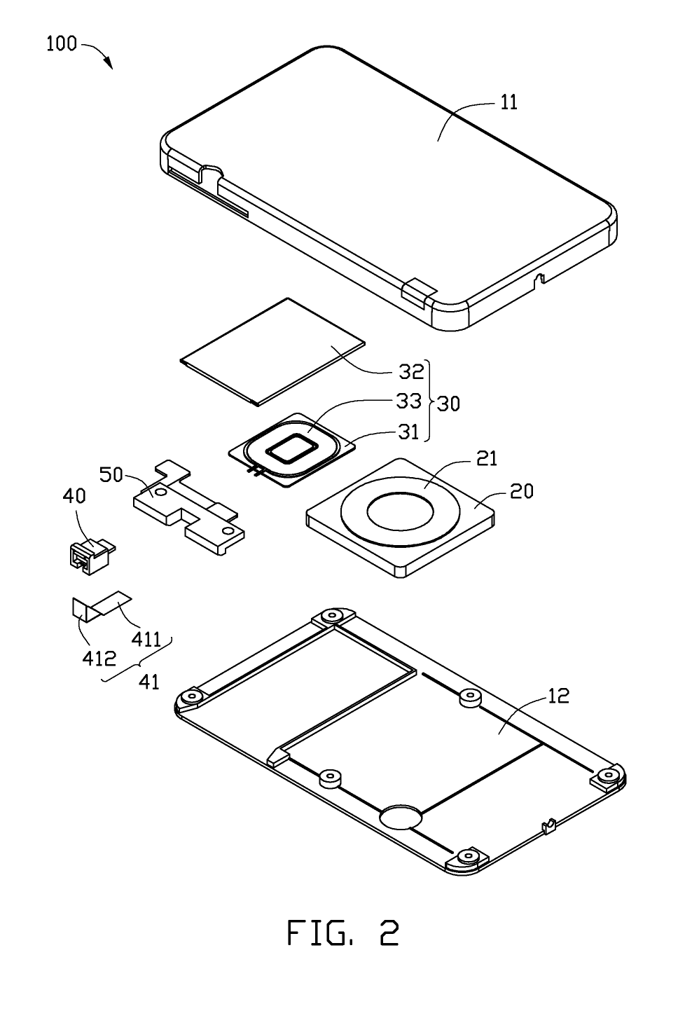

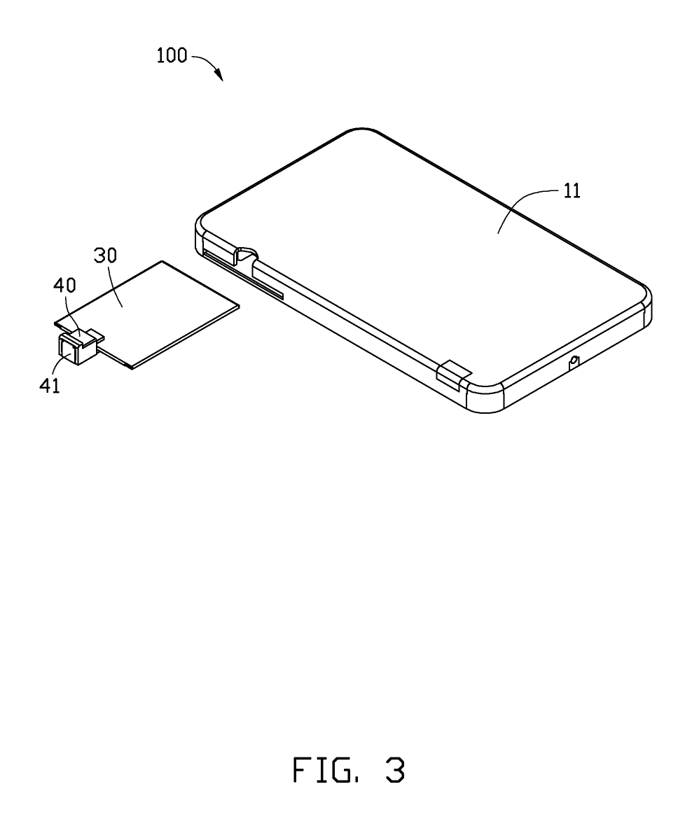

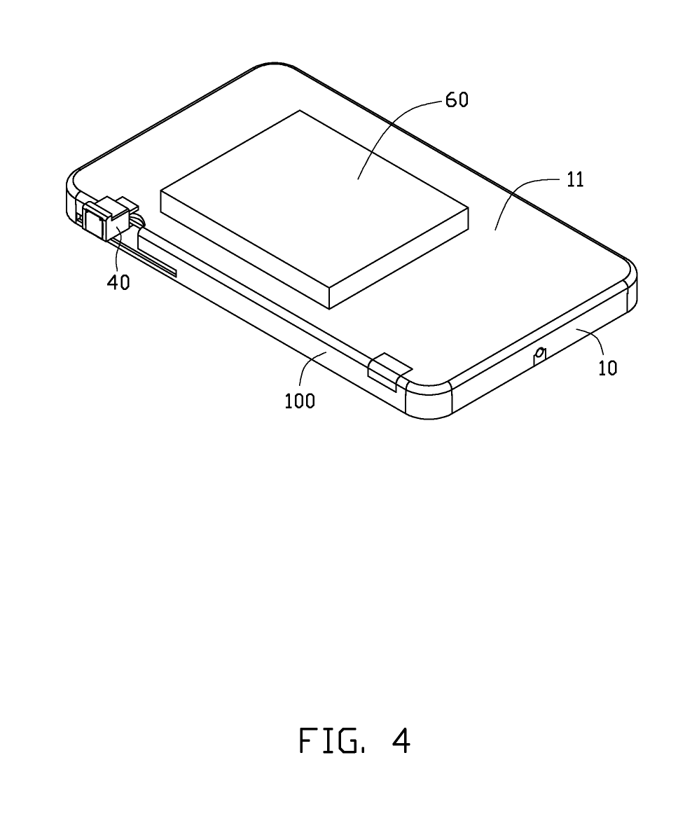

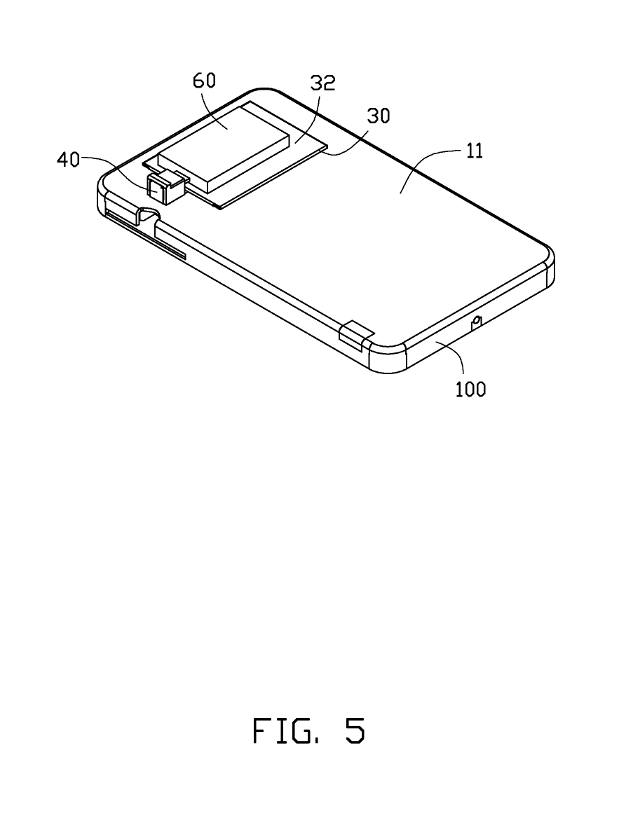

Referring to FIGS. 1 to 5, a wireless charging device 100 in accordance with an exemplary embodiment of the present disclosure is illustrated. The wireless charging device 100 is used for charging a portable electronic device 60 such as mobile phone. The wireless charging device 100 includes a housing 10, a transmitting unit 20, a receiving unit 30, an output port 40 and a wave-shielding plate 50.

The housing 10 includes a top cover 11 and a bottom cover 12 engaged with the top cover 11. The top cover 11 engages with the bottom cover 12 to define a cavity therebetween. The top cover 11 supports the portable electronic device 60.

The transmitting unit 20 is received in the cavity and includes a first coil 21. The transmitting unit 20 is electrically connected to an external power source for generating electromagnetic signals.

The receiving unit 30 includes a bottom charging panel 31, a top charging panel 32 and a second coil 33 arranged on the bottom charging panel 31. In the present embodiment, the bottom charging panel 31 engages with the top charging panel 32 to define a cavity for receiving the second coil 33. The second coil 33 receives the electromagnetic signals generated by the transmitting unit 20 to generate induction currents. The receiving unit 30 is received in the cavity defined by the housing 10. In an alternative embodiment, the receiving unit 30 can includes two or more than two second coils 33 with different shapes.

The output port 40 is electrically connected to the receiving unit 30 via a elastic sheet 41 for outputting the induction currents. In the present embodiment, the elastic sheet 41 is made of stainless steel, and the model can be SUS301. The elastic sheet 41 is substantial L-shape, and includes a first end 411 electrically connected to the bottom charging panel 31 of the receiving unit 30 and a second end 412 electrically connected to a side surface of the output port 40. In the present embodiment, the output port 40 is an USB port. The output port 40 is extractable and mounted to the housing 10.

The wave-shielding plate 50 is arranged between the transmitting unit 20 and receiving unit 30 for anti-jamming.

Also referring to FIG. 6, when using the wireless charging device 100, the portable electronic device 60 is charged via selectively electrically connected to the top cover 11 or the output port 40. If the portable electronic device 60 has the function of wireless charging, the portable electronic device 60 can be arranged on the top cover 11 to be charged wirelessly. If the portable electronic device 60 does not have the function of wireless charging, the portable electronic device 60 can be electrically connected to the output port 40 to be charged via the output port 40. In detail, the receiving unit 30 with the output port 40 are fetched out of the housing 10 and arranged on the top cover 11. The portable electronic device 60 is also arranged on the top charging panel 32 to connect the output port 40.

The wireless charging device 100 can be used for charging for portable electronic device 60 whether has the function of wireless charging or not; therefore, the wireless charging device 100 is suitable for various applications.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A wireless charging device for charging a portable electronic device, comprising:
a transmitting unit comprising a first coil for generating electromagnetic signals;
a receiving unit comprising a charging panel and at least one second coil arranged on the charging panel, the at least one second coil receiving the electromagnetic signals generated by the transmitting unit to generate induction currents; and
an output port electrically connected to the receiving unit for outputting the induction currents;
wherein the portable electronic device is selectively electrically connected to the charging panel or the output port for being charged.

2. The wireless charging device of claim 1, wherein the output port is an USB port.

3. The wireless charging device of claim 1, wherein the output port is electrically connected to the receiving unit via an elastic sheet.

4. The wireless charging device of claim 3, wherein the elastic sheet is made of stainless steel.

5. The wireless charging device of claim 3, wherein the elastic sheet is substantial L-shape.

6. The wireless charging device of claim 1, wherein the receiving unit comprises a plurality of second coils with different shapes.

7. The wireless charging device of claim 1, further comprising a wave-shielding plate arranged between the transmitting unit and receiving unit.

8. The wireless charging device of claim 1, further comprising a housing receiving the transmitting unit.

9. The wireless charging device of claim 8, wherein the receiving unit is extractable and mounted to the housing.

10. The wireless charging device of claim 9, wherein the receiving unit is inserted into the housing when the portable electronic device is electrically connected to the charging panel.

11. The wireless charging device of claim 9, wherein the receiving unit is pulled out of the housing and disposed on the housing when the portable electronic device is electrically connected to the output port.
